(19) United States
(12) Patent Application Publication
(10) Pub. No.: US 2009/0169457 A1
(43) Pub. Date: Jul. 2, 2009

(54) POLYSILANE PROCESSING AND USE

(76) Inventors: Gudrun Annette Auner, Glashütten (DE); Christian Bauch, Usingen (DE); Gerd Lippold, Leipzig (DE); Rumen Deltschew, Leipzig (DE)

Correspondence Address: K.F. ROSS P.C., 5683 RIVERDALE AVENUE, SUITE 203 BOX 900, BRONX, NY, 10471-0900, US

(21) Appl. No.: 12/374,339

(22) PCT Filed: Jul. 20, 2007
(86) PCT No.: PCT/EP2007/006487

§ 371 Date: Jan. 19, 2009

(30) Foreign Application Priority Data
Jul. 20, 2006 (DE) 102006034061.2

(51) Int. Cl. C01B 33/10; C07F 7/02

(52) U.S. Cl. 423/342; 556/430

(57) ABSTRACT

The invention relates to a method for the final product-related manufacture of low-molecular, medium-molecular, and high-molecular halogenated polysilanes, the distillation thereof into selected fractions, the direct deposition of silicon from the gas phase or a liquid phase of polysilane mixtures or polysilanes, the hydrogenation or derivation of halogenated polysilanes, and the processing into final products in an adequate system.

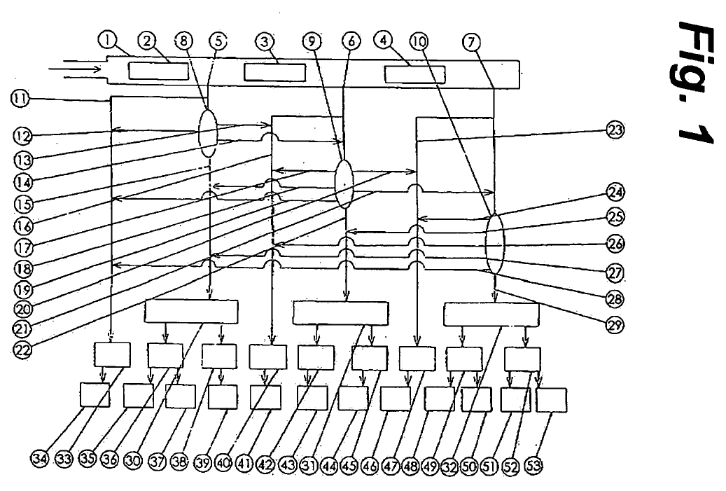

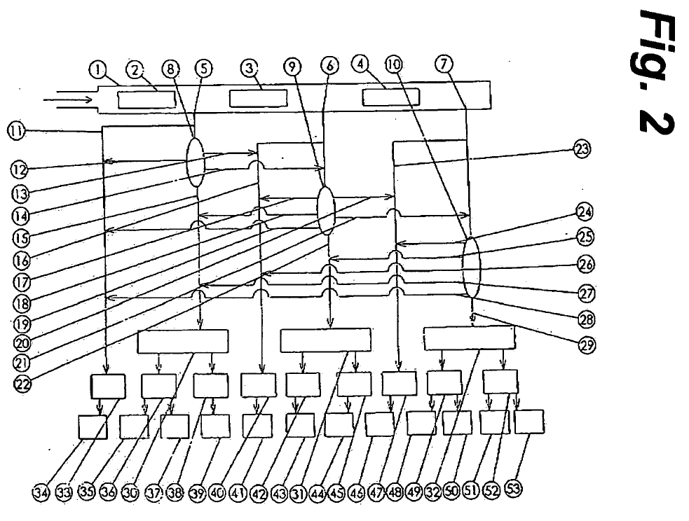

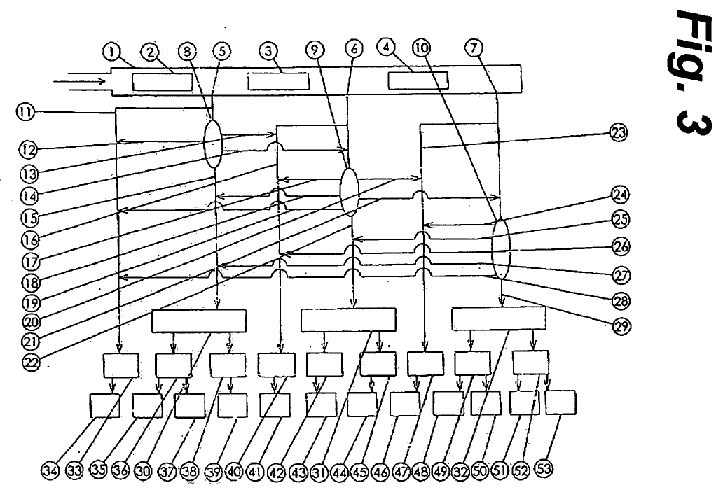

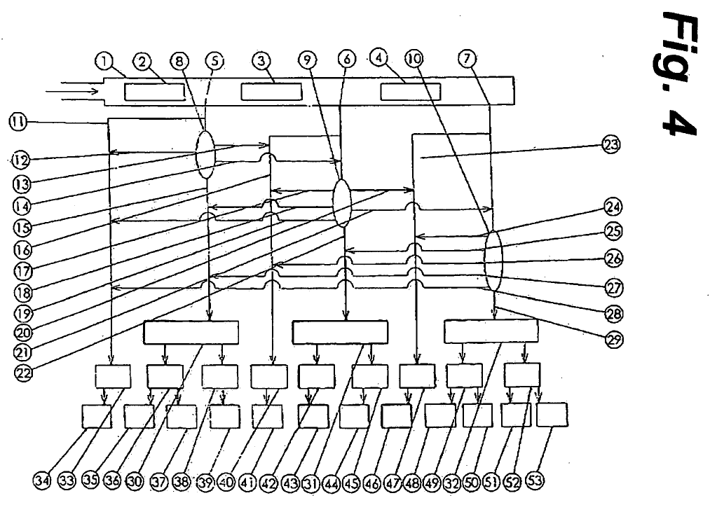

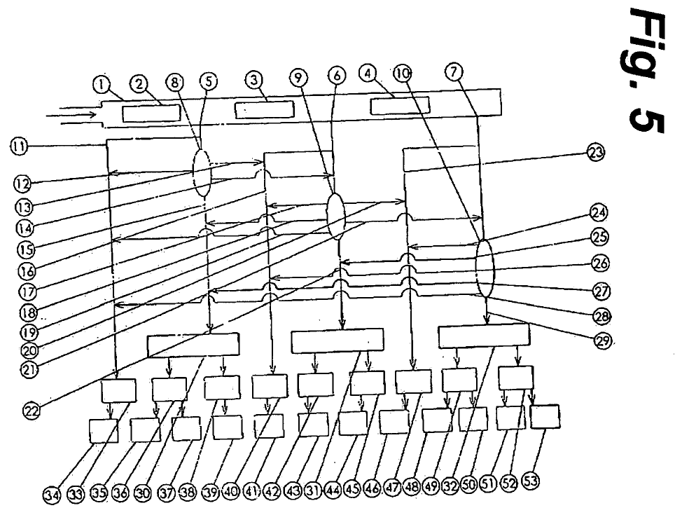

The invention is directed to a method for the final product-related production of halogenated polysilanes, the distillation, hydrogenation or derivation thereof and the processing into final products in an adequate system.

As polysilanes in the sense of the inventive method chemical compounds are designated which are characterized by at least one direct linkage Polysilanes can contain linear Siₙ chains and/or Siₙ rings as well as chain branchings.

Halogenated polysilanes in the sense of the inventive method are polysilanes the substituents of which largely consist of halogens X=F, Cl, Br, I as well as of hydrogen, Halogenated polysilanes in the sense of the inventive method are poor with respect to hydrogen with a ratio H:≦1:5.

Preparation of the Polysilanes

The mixture of halogenated polysilanes which can serve, among others, for the production of silicon is produced in a plasma chemical step from SiX₄ and H₂. This method is described in the patent application of Prof. Dr. Auner “Verfahren zur Herstellung von Silizium aus Halogensilanen” with the number PCT/D2006/00089. The plasma reaction can be carried out, for instance, through continuous stimulation)continuous wave):

A H₂/SiX₄ vapor mixture is stimulated by means of an electric or electromagnetic alternating field and is converted into the plasma-like condition—Dependent on the reaction conditions liquid, semi-solid or solid mixtures of halogenated polysilanes are produced.

According to the present understanding polysilanes with 2 to 6 silicon atoms are designated low-molecular polysilanes, polysilanes with 7 to 11 silicon atoms are designated medium-molecular polysilanes and polysilanes with at least 15 silicon atoms are designated high-molecular polysilanes. The selected groups are different with respect to their possibilities of further processing by distillation, hydrogenation or derivation.

According to the invention it is especially advantageous to control the reaction conditions in the plasma reactor in such a manner that not only any mixture of halogenated polysilanes is produced but the mixture of polysilanes which i5 m5st favorable for the further processing.

The specific halogenated polysilanes provided for further processing can be unambiguously determined especially by means of the molecular masses as well as additional suitable determining methods. One can produce low-molecular, medium-molecular and high-molecular halogenated polysilanes and characterize the same wherein cyclically structured polysilanes are also important with respect to the polymerization to obtain long-chain polysilanes.

It is advantageous to provide the plasma source located in the plasma reactor in several stages and to provide all possible measures for the aimed introduction of energy into a space volume as small as possible with a reaction mixture as homogeneous as possible.

This enables a high flow rate of the reaction mixture with largely homogeneous reaction conditions and thus largely homogeneous reaction products either.

It is decisive for a reaction product which is as homogeneous as possible to form the introduction of energy into the reaction plasma which has to be produced as homogeneously as possible and to provide reaction conditions as homogenous as possible in the plasma. Here it is advantageous to provide not only one plasma stimulation but several plasma stimulations which are passed subsequently by the reaction mixture.

In order to obtain an energy introduction into the space volume filled by the reaction mixture which is as uniform as possible it is advantageous to pulse the plasma source in order to obtain a more uniform stimulation of the reaction mixture.

The same object of a more homogeneous stimulation can be obtained by exposing the reaction mixture to an additional electron flow for achieving a more stable plasma or a better plasma ignition.

Additionally, the reaction mixture can be quenched by electromagnetic coils located at the outside of the reactor so that the reaction plasma is exposed to a compression with subsequent expansion. According to the invention it is also provided that the reaction mixture passes through a resonator chamber tuned to the wave length of the stimulation source.

It is advantageous to additionally expose the plasma to radiation of visible or ultraviolet light in order to be able to selectively stimulate ions or molecules in the reaction mixture.

It is decisive for a continuous operation of the system that the product mixture has a liquid (viscous) consistency so that it can flow out from the reactor in order to avoid occlusions.

The liquid consistency of the produced mixtures of halogenated polysilanes is obtained by operating in the reactor with SiX₄ excess and H₂ content as low as possible and by holding the temperature of the reactor below room temperature.

Accordingly, it is preferably if the mol concentration of hydrogen in the used gas mixture is smaller than the mol concentration of the SiX₄.

The characterization of the prepared polysilanes is made with the example of a mixture of chlorinated polysilanes as follows:

The volumetric determination of the chlorine content (chloride according to Mohr) of a sample solved in an aqueous lye results in the empirical formula SiCl₂₊ₓ for the mixture of polysilanes wherein x varies between 0 and 1 according to the mean chain length so that one can also speak of a polymer dichlorosilylene consisting of rings (x=0) and chains (0<×≦1) wherein the chains are terminated with —SiCl₃ groups. The structural formula of the rings is: SiₙCl₂ₙ and that of the chains is: SiₙCl₂ₙ₊₂.

EDX measurements confirm an atom ratio in the product of about Si:Cl=1:2, ²⁹Si-NMR measurements show that, dependent on the conditions of production, the product can be a complex mixture of different chlorinated polysilanes. Preferably, linear compounds are present as confirmed by the deficiency of signals of tertiary (Cl-Si/SiR₃)₃) and quaternary (Si(SiR₃) ₄) silicon atoms. ¹H-NMR measurements show that the product contains only traces of hydrogen (Si—H linkages).

The obtained mixtures of halogenated polysilanes are designated low-molecular, medium-molecular and high-molecular polysilanes. The mixture of low-molecular polysilanes consists largely of hexachlorodisilane (SiCl=1:3) and octachlorotrisilane Si₃Cl₈ (Si:Cl=1:2.67). These two components can be separated by distillation.

Separation of the mixture of polysilanes:

Individual components or fractions can be obtained from the product mixture, for example by distillation.

1. Hexachlorodisilane escapes at first at a temperature of about 144° C./1013 hPa wherein it can be already separated in the mixture in a vapor-like condition during the polysilane synthesis and can be condensed or instance 0° C.).

2. The next fraction is formed by the lower chlorinated oligosilanes, as for instance the octachlorotrisilane, the decachlorotrisilane and the decachloroisotetrasilane.

3. The polysilanes the decomposition temperatures of which are below the boiling points at normal pressure remain as residue.

Other separation methods, as vacuum distillation, sublimation, chromatography, selective crystallization, selective solving and centrifugation, are also suitable for separating the polysilanes of different molar weights from one another.

Hydrogenation of the polysilanes:

By the hydrogenation of the halogenated polysilanes partly hydrogenated and perhydrogenated compounds can be obtained, i.e. the halogen atoms are partly or completely replaced by hydrogen atoms. The hydrogenation can be carried out in inert solvents, as ethers, toluene etc., wherein, as hydrogenation agent preferably metal hydrides and metalloid hydrides are suited. Sodium aluminum hydride and several boron hydrides, as for instance sodium boron hydride, are to be especially mentioned in this connection. During the hydrogenation one should operate at temperatures (RT or lower) as low as possible in order to suppress a decomposition of the formed polysilanes. Preferably, only the desired fractions are hydrogenated so that a product/product mixture as uniform as possible is obtained.

Potential uses of the prepared polysilanes:

1. The complete pyrolysis of the product mixture or of individual components (halogenated polysilanes) results in the formation of silicon which, for instance, can be used for photovoltaic or microelectronic purposes if correspondingly pure starting compounds are used for the production of the polysilane.

2. After the distillative separation of the product mixture the components with high vapor pressure can be used for the separation of silicon layers (for instance a-Si, monocrystalline or polycrystalline silicon) from the gaseous phase on heated substrates wherein a heat treatment can be carried out inductively or by infrared radiation depending on the carrier material.

3. For this, for instance, the hexachlorodisilane and the lower oligosilanes are suited wherein silicon layers can be already deposited from temperatures of 400-500° C. not only in the presence of Hz but also without H₂. For this, the substances are passed in a vapor-like condition, also in a mixture with a carrier as (for instance H₂), over the heated substrate.

4. The components with low vapor pressure can be also used for the layer deposition of silicon from the product mixture or after separation of the fractions with higher vapor pressure if they are applied to a heatable substrate in substance or as solution and are pyrolyzed.

5. The deposition of silicon on the surfaces of substrates or the heat aftertreatment of a silicon layer produced on a substrate can be used for the formation of a compound with the substrate. So, for instance, the surface of metal substrates can be modified by the production of a metal silicide layer in order to obtain an increased abrasion resistance, a higher hardness or another surface

6. By the hydrogenation of the product mixture or of individual components completely or partly hydrogenated polysilanes can be obtained which are especially suited for the deposition of silicon layers or substrates at low temperature, for instance (SiₙH₂)ₙ→n Si+n H₂. Hereby, the volatile hydrogenated oligosilanes can be used for depositions from the gaseous phase. Then the less volatile hydrogenated polysilanes can be applied onto a carrier in an undiluted manner or as solution in inert solvents (for instance toluene) and can be decomposed by suitable measures (for instance heating, ultraviolet light etc.) so that a silicon layer is formed.

7. By the derivation of the product mixture or of individual components organopolysilanes can be obtained, as for instance partly methylated or permethylated compounds of the general formula SiₙXₐMe_{b} (a+b=2n) and SiₙX_{c}Me_{d} (c+d=2n+2). Then the organopolysilanes can be introduced into polymers, for instance by suitable coupling reactions (for instance Wurtz-couplings) or can be grafted onto existing polymers in order to use the special optical or electrical characteristics of the polysilane chain. In the inorganic synthetic chemistry different methods for the chemical conversion of differently substituted polysilanes by Chain splitting or ring opening as well as the partial replacement of substituents by, for instance, halogens are known. These methods can be applied to the primary polysilane mixture, to individual fractions after a separation, to separated pure compounds or to daughter products of the partly or complete substitution of the halogen atoms in the corresponding polysilanes. So, for instance, completely organosubstituted cyclic silanes can be converted by ring opening into chains which have halogen substituents only at the ends or at completely organosubstituted cyclosilanes only one or two substituents can be replaced by halogens under adapted conditions so that the ring system is maintained. A direct use of suitably derived polysilanes, for instance in the form of thin layers on suitable substrates, is possible. The manufacture of LED's is a possible use of the organopolysilanes.

8. Polysilanes having individual or several hydrogen substituents can be added to C—C multiple bonds by hydrosilylation so that, dependent on the reaction partners and the reaction conditions, hydrogen can be replaced by organosubstituents or copolymers with organic compounds as well as polysilane side chains at organic polymers can be produced.

9. Suitable C-substituted polysilanes produce silicon carbide if they are used as precursors and suitable nitrogen-substituted polysilanes produce silicon nitride when used as precursors. In this manner layers of silicon carbide or silicon nitride are accessible after an adapted processing of the precursors.

10. After separation (for instance distillatively) the halogenated polysilanes can be also used as fine chemicals for syntheses. So, for instance, hexachlorodisilane which, dependent on the plasma processing, is a main component of the product mixture can be used for deoxygenation reactions in the synthetic chemistry.

The inventive method for the use of polysilanes is shown in 5 drawings.

Drawing 1 shows the complete method scheme for processing.

Drawing 2 shows the use of the method scheme for the deposition of bulk silicon from halogenated polysilanes of small molar weight, as for instance hexachlorodisilane.

Drawing 3 shows the use of the method scheme for the hydrogenation and the deposition of thin layer silicon from hydrogenated polysilanes of small molar weight, as for instance disilane.

Drawing 4 shows the use of the method scheme for the partial methylation of halogenated polysilanes of medium molar weight, as for instance decachlorotetrasilane, and the further processing of these organochloropolysilanes by the Wurtz-coupling of these organopolysilanes to long-chain polymers when the low-molecular and high-molecular halogenated polysilanes are reconducted from the distillation into the store tank for low-molecular/high-molecular polysilanes and the high-molecular distillation residue is directed to the direct separation of silicon.

Drawing 5 shows the use of the method for the separation of high-molecular halogenated polysilanes, their methylation and subsequent processing to obtain organopolysilanes when the low-molecular and medium-molecular distillates are reconducted into the respective store tanks.

### LIST OF REFERENCE NUMBERS

1. Plasma reactor

2. electromagnetic radio frequency generator I

3. electromagnetic radio frequency generator II

4. electromagnetic radio frequency generator III

5. removal of predominantly low-molecular halogenated polysilanes

6. removal of predominantly medium-molecular halogenated polysilanes

7. removal of predominantly high-molecular halogenated polysilanes

8. distillation of predominantly low-molecular halogenated polysilanes

9. distillation of predominantly medium-molecular halogenated polysilanes

10. distillation of predominantly high-molecular halogenated polysilanes

11. removal of undistilled low-molecular halogenated polysilanes

12. removal of distillation residues

13. removal of distillation residues

14. removal of distillation residues

15. removal of low-molecular distillates

16. removal of undistilled medium-molecular halogenated polysilanes

17. removal of distillation residues

18. removal of distillation residues

19. removal of distillation residues

20. removal of distillation residues

21. removal of distillation residues

22. removal of medium-molecular distillates

23. removal of undistilled high-molecular halogenated polysilanes

24. removal of distillation residues

25. removal of distillation residues

26. removal of distillation residues

27. removal of distillation residues

28. removal of distillation residues

29. removal of high-molecular distillates

30. store tank of low-molecular halogenated polysilanes

31. store tank of medium-molecular halogenated polysilanes

32. store tank of high-molecular halogenated polysilanes

33. store tank of predominantly low-molecular halogenated polysilane mixtures

34. deposition device for silicon from low-molecular polysilane mixtures

35. deposition device for silicon layers from gaseous low-molecular hydrogenated polysilanes

36. hydrogenation reactor

37. store tank of liquid low-molecular hydrogenated polysilanes

38. methylation reactor

39. store tank of low-molecular organopolysilanes

40. store tank of predominantly medium-molecular halogenated polysilane mixtures

41. deposition device for silicon from medium-molecular polysilane mixtures

42. hydrogenation reactor

43. deposition device for silicon layers from gaseous medium-molecular hydrogenated polysilanes

44. store Lank of medium-molecular organopolysilanes

45. methylation reactor

46. deposition device for silicon from high-molecular polysilane mixtures

47. store tank of predominantly high-molecular halogenated polysilane mixtures

48. deposition device for silicon layers from gaseous high-molecular hydrogenated polysilanes

49. hydrogenation reactor

50. store tank of liquid high-molecular hydrogenated polysilanes

51. store tank of gaseous high-molecular organopolysilanes

52. methylation reactor

53. store tank of liquid high-molecular organopolysilanes

1. A method for the final product-related production and processing of mixtures of halogenated polysilanes for the generation of silicon or silicon-based products wherein, dependent on the generated polysilane mixture of low, medium or high molecular weight and the desired end product and/or intermediate product,
this mixture of halogenated polysilanes in the gaseous or liquid phase is either
directly led to the further processing or is
separated in one distillation column or a plurality of distillation columns in individual fractions and the distillates are directly processed and are led to further processing steps, as for instance
a hydrogenation of the halogenated polysilanes or
a methylation to obtain organopolysilanes, and
the polysilane mixture coming to the processing is controlled in its composition by the regulation of the production process and the flow of substances.

2. The method for the final product-related production and processing of mixtures of halogenated polysilanes for the generation of silicon and/or silicon-based products according to claim 1 wherein the mixtures of halogenated polysilanes are produced chemically or plasma chemically.

3. The method for the final product-related production and processing of mixtures of halogenated polysilanes according to claim 2 wherein for the control of the composition of the polysilane mixture one or more plasma reactors are subsequently passed by the supplied reaction mixture of halogen silane and H₂ and the mean molecular weight of the mixture of polysilanes increases after passage of each plasma reactor.

4. The method for the final product-related production and processing of plasma chemically produced mixtures of halogenated polysilanes according to claim 1 wherein for controlling the composition of the polysilane mixture in a plasma reactor a plurality of plasma sources are provided and the same are passed by the reaction mixture and after each plasma source in the plasma reactor the mean molecular weight of the polysilane mixture increases.

5. The method for the final product-related production and processing of plasma chemically produced mixtures of halogenated polysilanes according to claim 4 wherein, dependent on the number of plasma reactors or of plasma sources, in a plasma reactor polysilane mixtures of predominantly low, medium and high molecular weight are obtained which are led to further processing.

6. The method for the final product-related production and processing of plasma chemically produced mixtures of halogenated polysilanes according to claim 3 wherein the temperature of the plasma reactor or of individual components is maintained below ambient temperature and the viscosity of the obtained polysilane mixture is controlled by the mixing ratio between the hydrogen content and the halogen content of the gas mixture.

7. The method for the final product-related production and processing of plasma chemically produced mixtures of halogenated polysilanes according to claim 4 wherein the plasma sources used in the plasma reactor are pulsed.

8. The method for the final product-related production and processing of plasma chemically produced mixtures of halogenated polysilanes according to claim 7 wherein the plasma in the plasma reactor is periodically quenched by an additional electromagnetic alternating field or passes a resonator chamber tuned to the microwave source.

9. The method for the final product-related production and processing of plasma chemically produced mixtures of halogenated polysilanes according to claim 1 wherein plasma pulsing and/or additional electrical discharge and/or plasma quenching alternate in the plasma reactor.

10. The method for the final product-related production and processing of plasma chemically produced mixtures of halogenated polysilanes according to claim 3 wherein the plasma in the plasma reactor is additionally radiated with infrared light, visible light or ultraviolet light.

11. The method for the final product-related production and processing of mixtures of halogenated polysilanes according to claim 1 wherein the predominantly low-molecular polysilane mixtures are led to a distillation to obtain low-molecular halogenated polysilanes, as for instance Si₂Cl₆ and Si₃Cl₈, in a pure condition.

12. The method for the final product-related production and processing of mixtures of halogenated polysilanes according to claim 1 wherein the distillation residue with predominantly medium molecular weight, as for instance Si₅X₁₂ or Si₅X₁₀, is led to a direct further processing or is led into another distillation column.

13. The method for the final product-related production and processing of mixtures of halogenated polysilanes according to claim 1 wherein the polysilane mixtures with predominantly undecomposed distillable components of medium molecular weight are led to a distillation to obtain individual components in pure condition and/or fractions of defined boiling ranges.

14. The method for the final product-related production and processing of mixtures of halogenated polysilanes according to claim 1 wherein the distillates or distillation residues with predominantly low or high molecular weights are led to a direct further processing or are led into another distillation column.

15. The method for the final product-related production and processing of mixtures of halogenated polysilanes according to claim 1 to 10 wherein the predominantly high-molecular polysilane mixtures are exposed to the separation method of the size-selective chromatography to obtain polysilane fractions with high medium molecular weights.

16. The method for the final product-related production and processing of mixtures of halogenated polysilanes according to claim 1 wherein the separation fraction with predominantly low or medium molecular weights is led to a direct further processing or into another distillation column.

17. The method for the final product-related production and processing of mixtures of halogenated polysilanes according to claim 1 wherein the polysilanes with low, medium or high molecular weight obtained after the distillation or other separation methods are hydrogenated and partly hydrogenated or perhydrogenated compounds are obtained.

18. The method for the final product-related production and processing of mixtures of halogenated polysilanes according to claim 1 wherein the hydrogenation is carried out in ethers and/or aromatic solvents.

19. The method for the final product-related production and processing of mixtures of halogenated polysilanes according to claim 1 wherein metal hydrides and metalloid hydrides, preferably sodium aluminum hydride or sodium boron hydride, are used as hydrogenation agents.

20. The method for the final product-related production and processing of mixtures of halogenated polysilanes according to claim 1 wherein the hydrogenation is preferably carried out at temperatures below 20° C.

21. The method for the final product-related production and processing of mixtures of halogenated polysilanes according to claim 1 wherein the polysilanes with low, medium and high molecular weight obtained after the distillation are methylated and partly methylated or permethylated organopolysilanes of the formula SiₙXₐMe_{b}(a+b=2n) and SiₙX_{c}Me_{d}(c+d=2n+2) are obtained.

22. The method for the final product-related production and processing of mixtures of halogenated polysilanes according to claim 1 wherein metalloid compounds and/or metalorganic compounds, as for instance methyl lithium, methyl magnesium halide, dimethyl zinc, tetramethyl silane, are used as methylation agent.

23. The method for the final product-related production and processing of mixtures of halogenated polysilanes according to claim 1 wherein the obtained hydrogenated polysilanes are introduced into polymers or are grafted onto the same.

24. The method for the final product-related production and processing of mixtures of halogenated polysilanes according to claim 1 wherein mixtures of low-molecular halogenated polysilanes are directed over a heated surface directly from the gaseous phase for the deposition of silicon and are pyrolytically decomposed there.

25. The method for the final product-related production and processing of mixtures of halogenated polysilanes according to claim 1 wherein liquid halogenated polysilane mixtures or their solutions are applied in suitable solvents onto deposition surfaces and are decomposed there by pyrolysis wherein silicon is deposited there.

26. The method for the final product-related production and processing of mixtures of halogenated polysilanes according to claim 1 wherein hydrogenated polysilanes with high purity of selected molecular weights are directed over heated surfaces in the gaseous phase and silicon is deposited on these surfaces by pyrolysis.

27. The method for the final product-related production and processing of mixtures of halogenated polysilanes according to claim 1 to 20 wherein hydrogenated polysilanes of selected molecular weights are applied onto suitable surfaces in the liquid phase or in solution and are decomposed by heating whereby silicon is deposited on these surfaces.

28. The method for the final product-related production and processing of mixtures of halogenated polysilanes according to claim 1 wherein amorphous silicon thin layers on any carrier surfaces are obtained as final product.

29. The method for the final product-related production and processing of mixtures of halogenated polysilanes according to claim 1 wherein polycrystalline silicon thin layers are obtained on any carrier surfaces.

30. The method for the final product-related production and processing of mixtures of halogenated polysilanes according to claim 1 wherein monocrystalline silicon thin layers on any carrier surfaces are obtained.

31. The method for the final product-related production and processing of mixtures of halogenated polysilanes according to claim 1 wherein silicon is deposited as layer of any thickness from mixtures of halogenated polysilanes above 400° C. or hydrogenated polysilanes above 200° C.

32. The method for the final product-related production and processing of mixtures of halogenated polysilanes according to claim 1 wherein the deposited silicon layers are exposed to a heat aftertreatment.
